(19) United States
(12) Patent Application Publication
(10) Pub. No.: US 2023/0037693 A1
(43) Pub. Date: Feb. 9, 2023

(54) LIQUID SUPPLY SYSTEMS, SPOUT SUPPORT TOOLS, AND METHODS OF USING

(71) Applicant: Siemens Healthcare Diagnostics Inc., Tarrytown, NY (US)

(72) Inventor: Marthinus Jacobus Bekker, Fuquay Varina, NC (US)

(73) Assignee: Siemens Healthcare Diagnostics Inc., Tarrytown, NY (US)

(21) Appl. No.: 17/758,726

(22) PCT Filed: Jul. 2, 2020
(86) PCT No.: PCT/US2020/070229

§ 371 Date: Jul. 13, 2022

(51) Int. Cl. B65D 77/06; B65D 25/44; F16L 3/123

(52) U.S. Cl. CPC B65D 77/065; B65D 25/44; F16L 3/123; B65D 2577/041

(57) ABSTRACT

Liquid supply system for an analyzer. Liquid supply system includes a liquid-containing container and a spout support tool. Liquid-containing container is made up of a rectangular parallelepiped box comprising a wall with an opening therein, and a collapsible insert including a liquid-containing portion received inside the rectangular parallelepiped box. The collapsible insert includes a spout with a flange wherein both are retractable through the opening. The support tool has a body having an engaging portion and a grasping portion, the engaging portion includes a first engagement surface engaged with a surface of the wall, a second engagement surface, and a spout receiver formed in the engaging portion that is configured to be received under the flange to support the spout. pout support tools and retaining methods of a liquid supply system are provided, as are other aspects.

### CROSS REFERENCE TO RELATED APPLICATION

This application claims priority to, and the benefit of, U.S. Design patent application Ser. No. 29/723,023, entitled “CUBITAINER SPOUT SUPPORT TOOL” filed February 04, 2020, the disclosure of which is hereby incorporated by reference in its entirety for all purposes.

### FIELD

The present disclosure relates to liquid supply systems including box-like containers made of an outer box-shaped enclosure with a collapsible insert configured to contain a fluid and their methods of use.

### BACKGROUND

Testing within diagnostic laboratories, for example, may involve using analyzers for extracting and quantifying one or more constituents in a biological sample obtained from a patient, such as from blood serum or blood plasma, cerebrospinal fluid, urine, and the like.

In such biological sample processing using such analyzers, liquid materials are used, such as liquid reagents. Such liquid reagent can be supplied in bulk within a liquid supply container 200 (sometimes referred to as box-in-bag container), which can have an external box-shaped enclosure 202, which may be made of cardboard, and an internal collapsible container 204 (or bag) including a pour spout 206, which may be molded plastic, such as shown in FIGS. 2A-2C. Pour spout 206 is integrally attached to the bag 208 and may include a spout neck 210, a threaded portion 212 onto which a cap 214 may be secured to close and seal the internal collapsible container 204, and a flange 216 located below the threaded portion 212 and cap 214. For storage and shipment, the spout 206 and spout neck 210, flange 216, and cap 214 may be pushed inside of the external box-shaped enclosure 202 through hole 218 formed therein. Once the spout 206 is pushed in, the hole 218 may be closed with a lid 202L as shown in FIG. 2A.

### SUMMARY

According to first aspect, a liquid supply system is provided. The liquid supply system includes a liquid-containing container made up of a rectangular parallelepiped box comprising a wall with an opening formed therein, and a collapsible insert including a liquid-containing reservoir received inside of the rectangular parallelepiped box, the collapsible insert further including a spout with a flange wherein the spout and flange are retractable through the opening in the wall; and a support tool comprising a body having an engaging portion and a grasping portion extending from engaging portion, the engaging portion including a first engagement surface engaged with a surface of the wall and a second engagement surface opposite the first engagement surface, and a spout receiver formed in the engaging portion that is configured to be received under the flange of the spout of the liquid-containing container to support the spout.

According to another aspect, a support tool is provided. The support tool includes a body having an engaging portion and a grasping portion extending from engaging portion, the engaging portion including a first engagement surface and a second engagement surface opposite the first engagement surface, and a spout receiver formed in the engaging portion that is configured to receive and support a spout of a liquid-containing container.

In another aspect, a retaining method of a liquid supply system is provided. The method includes providing a liquid-containing container made up of a rectangular parallelepiped box comprising a wall with an opening formed therein, and a collapsible insert including a liquid-containing portion received within the rectangular parallelepiped box, the collapsible insert including a spout with a flange wherein the spout and flange are retractable through the opening in the wall; providing a support tool comprising a body having an engaging portion and a grasping portion extending from engaging portion, the engaging portion including a first engagement surface and a second engagement surface opposite the first engagement surface, and a spout receiver formed in the engaging portion that is configured to receive a spout of the collapsible insert; and grasping the grasping portion and inserting the spout receiver of the engaging portion over the spout such that the first engagement surface is provided in contact with the flange and the second engagement surface is in contact with the wall, thus preventing the spout from retracting into an interior of the rectangular parallelepiped box.

Still other aspects, features, and advantages of the present disclosure may be readily apparent from the following detailed description by illustrating a number of example embodiments and implementations. The present invention may also be capable of other and different embodiments, and its several details may be modified in various respects. The disclosure is to cover all modifications, equivalents, and alternatives falling within the scope of the claims.

### BRIEF DESCRIPTION OF THE DRAWINGS

The disclosure will be better understood by referring to the detailed description taken in conjunction with the following drawings. The drawings and descriptions are to be regarded as illustrative in nature, and not as restrictive. The drawings are not necessarily drawn to scale. Like numerals are used throughout to denote like elements.

FIG. 1A illustrates a top perspective view of a spout support tool according to the disclosure.

FIG. 1B illustrates a front elevation view of a spout support tool according to the disclosure.

FIG. 1C illustrates a rear elevation view of a spout support tool according to the disclosure.

FIG. 1D illustrates a top plan view of a spout support tool according to the disclosure.

FIG. 1E illustrates a bottom plan view of a spout support tool according to the disclosure.

FIG. 1F illustrates a right side elevation view of a spout support tool according to the disclosure.

FIG. 1F illustrates a left side elevation view of a spout support tool according to the disclosure.

FIG. 2A illustrates a side perspective view of a liquid supply container closed with a lid according to the prior art.

FIG. 2B illustrates a side perspective view of a liquid supply container with the lid removed and the spout (with a flange and cap) of the internal collapsible container pulled out of the interior of a rectangular parallelepiped box enabling access to the contained liquid reagent according to the prior art.

FIGS. 2C illustrates a front perspective view of a collapsible insert according to the prior art.

FIG. 3A illustrates a liquid supply container with a support tool installed thereon and supporting the spout so that it cannot fall back into the rectangular parallelepiped box as the liquid (e.g., liquid reagent) is drawn down according to the disclosure.

FIG. 3B illustrates a liquid supply container with a support tool installed and shown supporting the spout as well as a liquid supply tube according to the disclosure.

FIG. 4 is a flowchart illustrating a retaining method of a liquid supply system according to the disclosure.

### DETAILED DESCRIPTION

The present disclosure is directed at liquid supply system and spout support tool for use in the system. The supplied liquid from the liquid supply system may be a liquid reagent to be used in testing conducted by a fluidly connected analyzer to determine the presence and/or quantity of a particular analyte in a bio-fluid sample. Bio-fluid sample may be, for example, blood serum, blood plasma, urine, cerebrospinal fluid, and the like. In particular, the liquid supply system can provide an un-interrupted supply of a process liquid, such as the liquid reagent from a liquid-containing container to an analyzer. Moreover, the liquid supply system can include a support tool as described herein to avoid spills by providing proper support of the spout as liquid reagent is used and the liquid level falls. The support tool can be provided along with the liquid supply container and may be reused. Liquid-containing container is made up of a rectangular parallelepiped box comprising walls with one wall having an opening formed therein, and a collapsible insert including a liquid-containing portion received inside of the rectangular parallelepiped box, the collapsible insert further including a spout. The rectangular parallelepiped box with collapsible insert is sometimes referred to as a “CUBITAINER” or Bag-in-box.

In another aspect, a support tool for a spout of a liquid-containing container made up of a rectangular parallelepiped box and a collapsible insert is provided.

In yet another aspect, a retaining method of a liquid supply system is provided wherein a spout support tool is used to retain a spout of the liquid-containing container, such that the spout does not retract inside of the rectangular parallelepiped box and cause a spill.

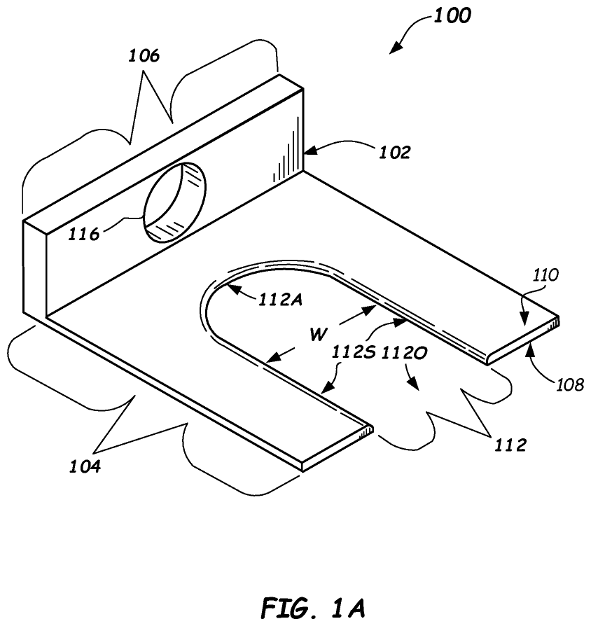

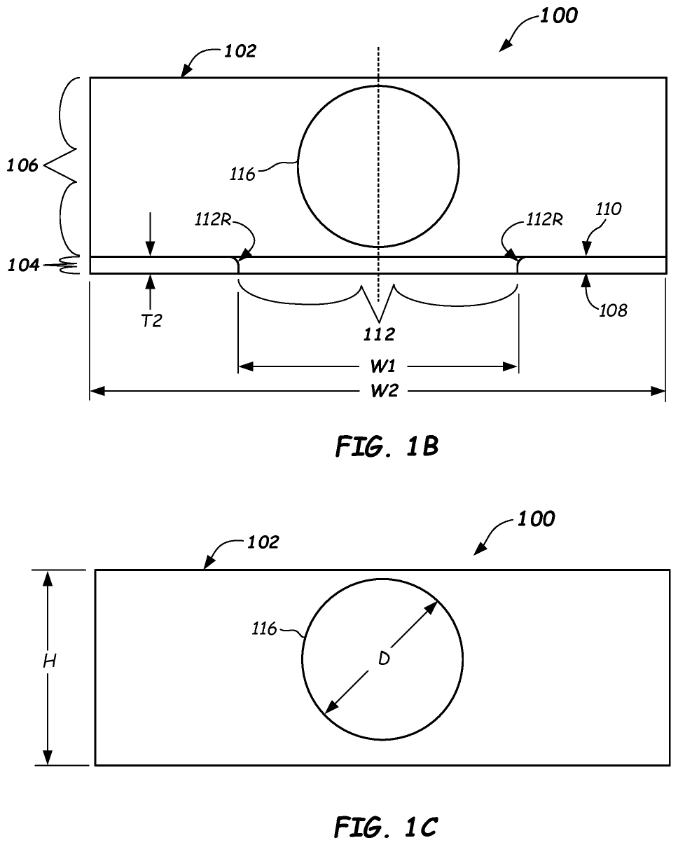

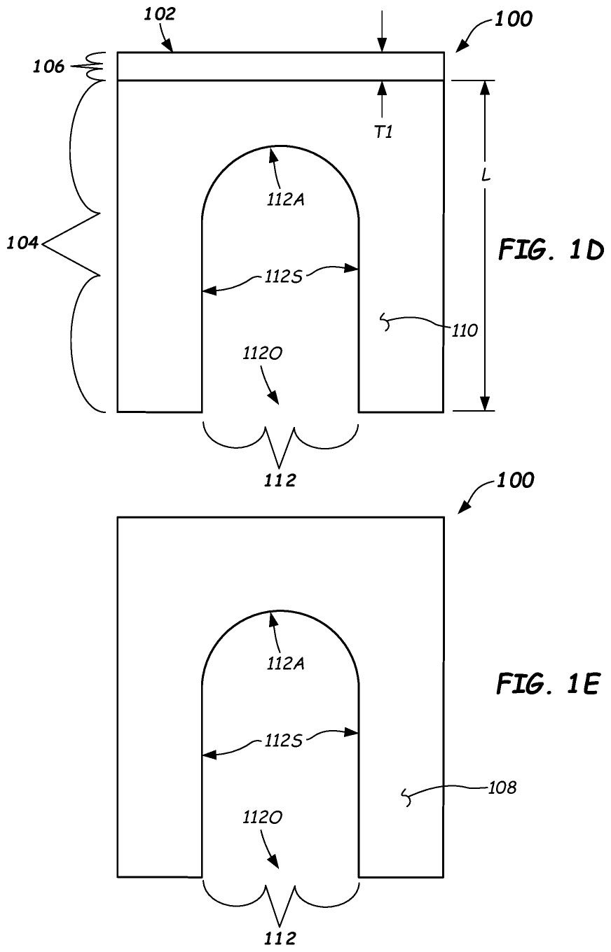

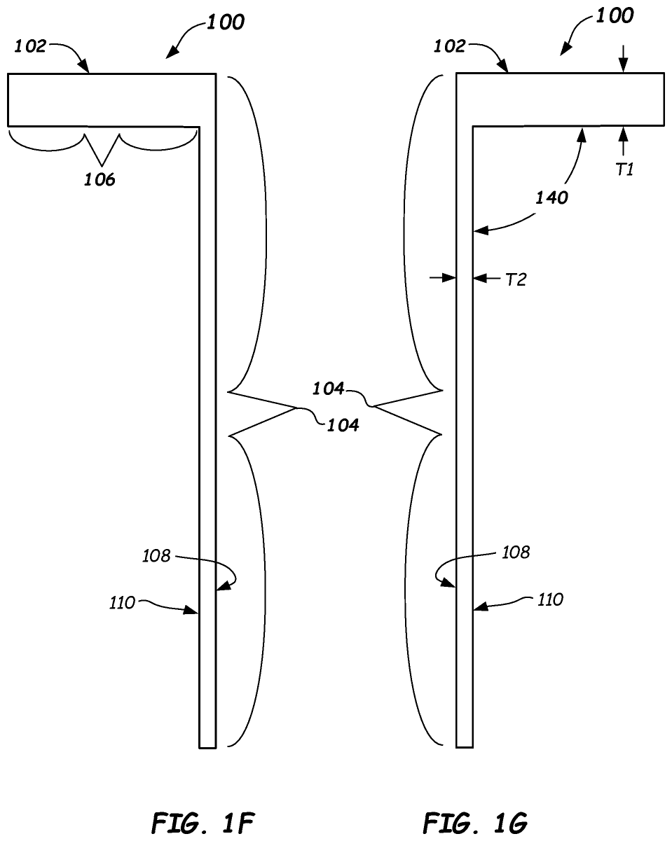

These and other aspects and features of embodiments of the liquid supply systems, spout support tools, and retaining methods of a liquid supply system of the disclosure will be described with reference to FIGS. 1A-4 herein.

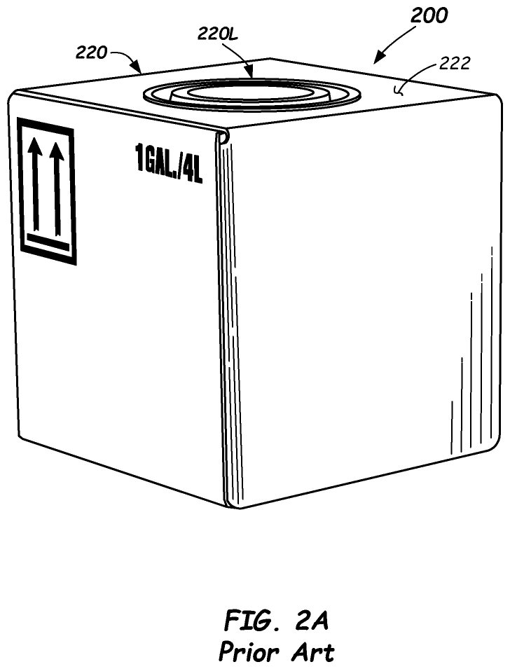

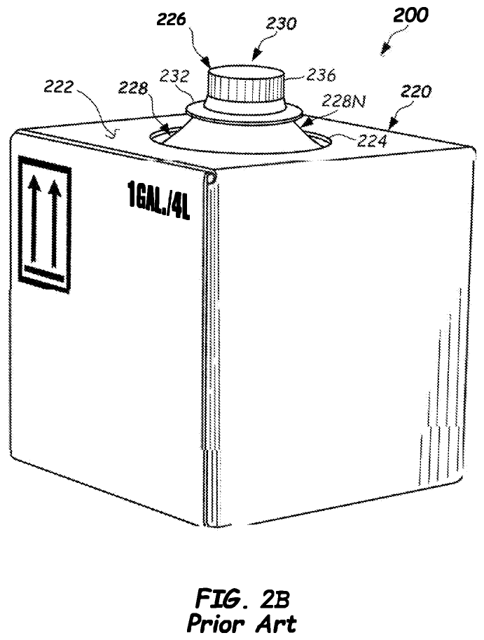

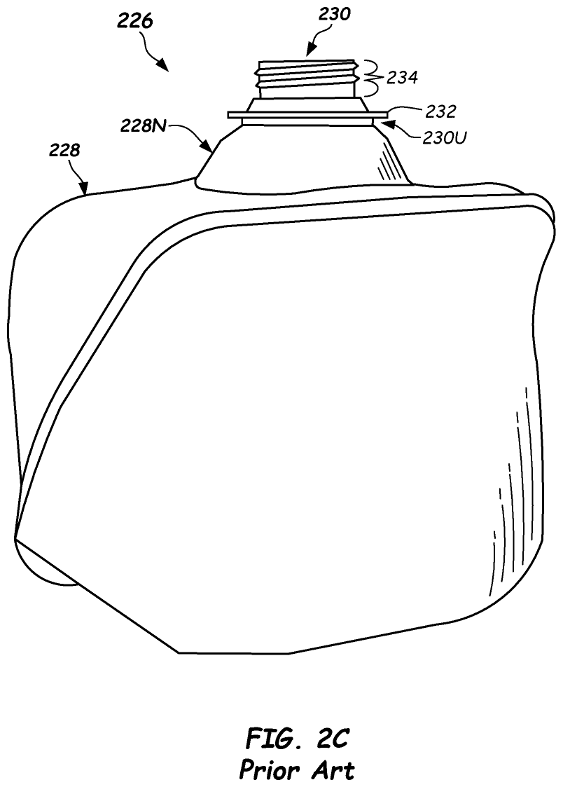

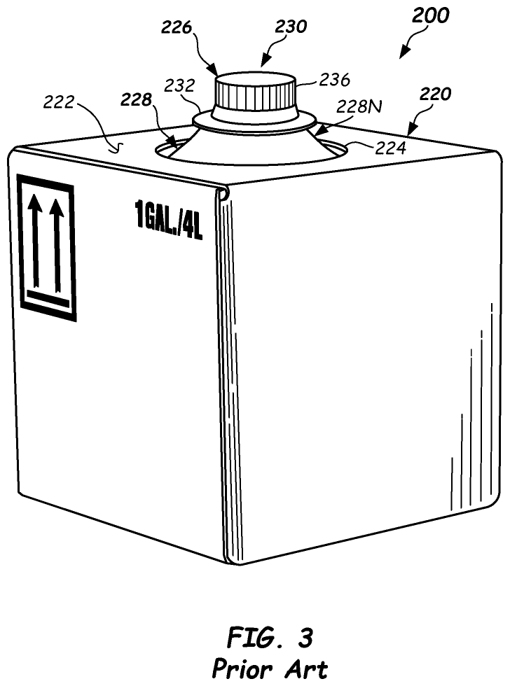

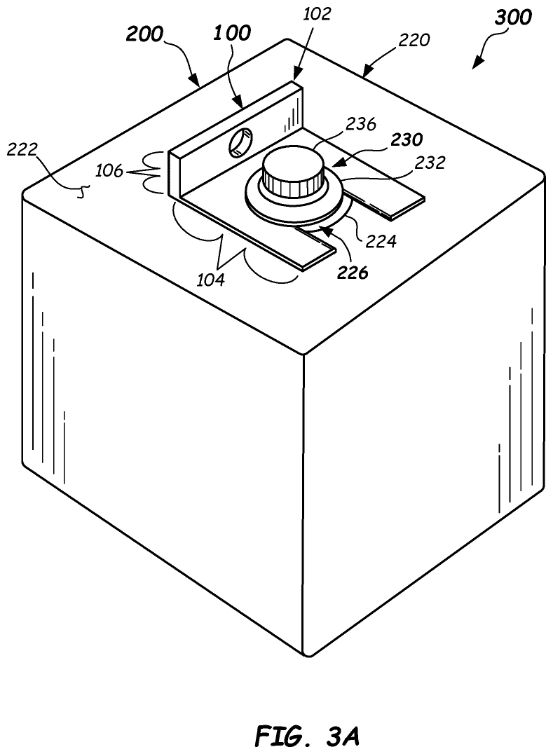

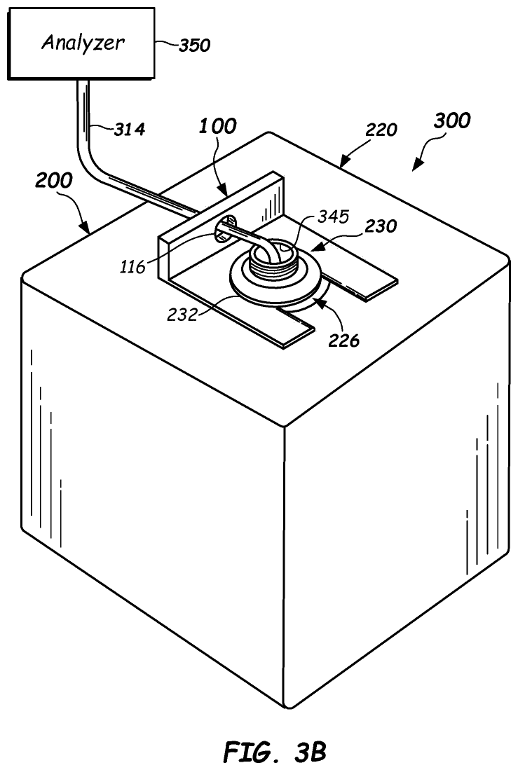

Referring now to FIG. 3A, an embodiment of liquid supply system 300 is shown and described. Liquid supply system 300 comprises a liquid-containing container 200 and a spout support tool 100. Liquid-containing container 200 is made up of a rectangular parallelepiped box 220 comprising a plurality of walls, each of which may be planar walls. Wall 222, such as upper wall, includes an opening 224 formed therein. The collapsible insert 226, as best shown in FIG. 2C, includes a liquid-containing portion 228 that comprises a reservoir that contains the liquid reagent and a spout 230 sealed and coupled to the liquid-containing portion 228.

The liquid-containing portion 228 is received inside of an interior of the rectangular parallelepiped box 220. Liquid-containing portion 228 can include a neck 228N that transitions to the spout 230 in some embodiments. Neck 228N can be a portion of the liquid-containing portion 228 that flexes as the spout 230 is pushed into the rectangular parallelepiped box 220 and closed with lid 220L as shown in FIG. 2A. The configuration shown in FIG. 2C can be for shipping and/or storage allowing the liquid-containing container 200 to be stacked.

Rectangular parallelepiped box 220 can be a square parallelepiped box, wherein all walls are approximately the same size and approximately square shape. In particular, the rectangular parallelepiped box 220 can comprise a hollow square parallelepiped made of cardboard.

The collapsible insert 226 (FIG. 2C) further includes a flange 232 provided on the spout 230. The spout 230 can further include a threaded portion 234 formed thereon and a container opening at the terminal end of the spout 230 through which the liquid reagent can be dispensed. Threaded portion 234 is configured to receive a threaded cap 236 (FIG. 2B). The inventors herein discovered that under some circumstances, when liquid reagent inside the liquid-containing portion 228 is withdrawn and used to conduct tests by the analyzer 350 (FIG. 3B), the spout 230 and flange 232 can retract through the opening 224 in the wall 222. In some instances, this can cause spills inside of the rectangular parallelepiped box 220 when the spout opening falls below the liquid reagent level. To solve this problem, a spout support tool 100 as shown in FIG. 1, for example, is provided and used to support the spout 230 and retain the spout 230 in a defined orientation relative to the wall 222 of the rectangular parallelepiped box 220.

In more detail, the spout support tool 100 comprises, as shown in FIGS. 1A-1G, a body 102 having an engaging portion 104 and a grasping portion 106 extending from engaging portion 104. The engaging portion 104 includes a first (lower as shown) engagement surface 108 that is configured to be engaged with a surface of the wall 222 and a second (upper as shown) engagement surface 110 provided opposite the first engagement surface 108. Engagement surface 108 may be a planar surface and is configured to be engaged with a planar surface (e.g. top planar surface) of the wall 222. Spout support tool 100 further comprises a spout receiver 112 formed in the engaging portion 104 that comprises an opening that is configured to be received under the flange 232 of the spout 230 of the liquid-containing container 226. Thus, the spout support tool 100 prevents the spout 230 from retracting into the interior of the rectangular parallelepiped box 220 upon removal of liquid reagent from the liquid-containing portion 228. Thus, the spout support tool 100 effectively supports the spout 230 and keeps the spout 230 from falling through the opening 224.

The spout receiver 112 is, as shown in FIGS. 3A-3B, received underneath and in contact with the flange 232 of the spout 230. Spout receiver 112 can comprise, as shown, an open end 1120, two sides 112S, which may be parallel with each other, and an arcuate portion 112A extending between the two sides. A width W1 of the spout receiver 112 can be configured to be slightly larger than a width of a portion 230U (FIG. 2C) of the spout 230 located below the flange 232, but also narrower than a width of the flange 232. The overall width of the engaging portion 104 should be slightly larger than the opening 224 in the rectangular parallelepiped box 220. By way of example, and not by limitation, the engaging portion 104 can have a length L of from 55 mm to 110 mm, and overall width W2 of from 81 mm to 109 mm. Other suitable dimensions may be used.

In some embodiments, the spout receiver 112 can include a formed radius 112R (FIG. 1B) of a suitable dimension along some or all of an upper edge thereof. The formed radius 112R can minimize any possible cutting into the portion 230U of the spout 230 below the flange 232. The formed radius 112R can have a radius dimension of from 1 mm to 4 mm, for example. The spout support tool 100 may be manufactured from any suitable molded polymer or plastic, such as acrylonitrile butadiene styrene (ABS), polyethylene, polycarbonate, or the like, for example. Other suitably-rigid materials may be used.

As shown, grasping portion 106 can further comprise an aperture 116, such as circular through hole shown. Aperture 116 may be located and positioned in line with a center of a width W1 of the spout receiver 112 (FIG. 1B), so as to align the aperture 116 with the spout 230. Aperture 116 of the spout support tool 100 may provide a useful feature for a user to grasp when inserting the spout support tool 100 underneath the flange 232. However, in some system embodiments at least one liquid supply tube 314 (FIG. 3B) that is coupled to the analyzer 350 may be received through the aperture 116. Liquid supply tube 314 can supply liquid reagent to the analyzer 350 from the liquid-containing container 200 that is used for conducting tests therewith. Thus, the aperture 116 is configured (sized) to receive a liquid supply tube 314 there through so that the liquid supply tube 314 can be supported relative to the spout 230 and is less likely to become dislodged from the spout 230 or be pulled up from the bottom of the liquid-containing portion 228. Thus, a diameter D of the aperture 116 (FIG. 1C) can be from 10 mm to 30 mm, for example. Other suitable sizes and shapes of the aperture 116 may be used. The at least one liquid supply tube 314 may also be inserted and received into the opening 345 of the spout 230 and preferably reaches to the bottom of the liquid-containing portion 228.

In some embodiments, more than one liquid supply tube 314 can be received through the aperture 116 and into the spout 230. In some embodiments, the grasping portion 106 can extend approximately perpendicularly from engaging portion 104, such as at an end of the engaging portion 104 and further can extend away from the wall 222 in an as-installed condition as is shown in FIGS. 3A-3B. “Approximately perpendicularly” as used herein means that the angle 140 (FIG. 1G) between the second engagement surface 110 and the front face of the grasping portion 106 is from 70 degrees and 110 degrees. In some embodiments, the grasping portion 106 can have a thickness T1 that is thicker than a thickness T2 of the engaging portion 104. Thickness T1 may be from 3 mm to 10 mm, whereas thickness T2 may be from 2 mm to 3 mm, for example. Further, grasping portion 106 can extend laterally to a full width of the engaging portion 104, and may have a height H of from 16.5 mm to 33 mm, for example. Other suitable thicknesses T1, T2 and height H may be used.

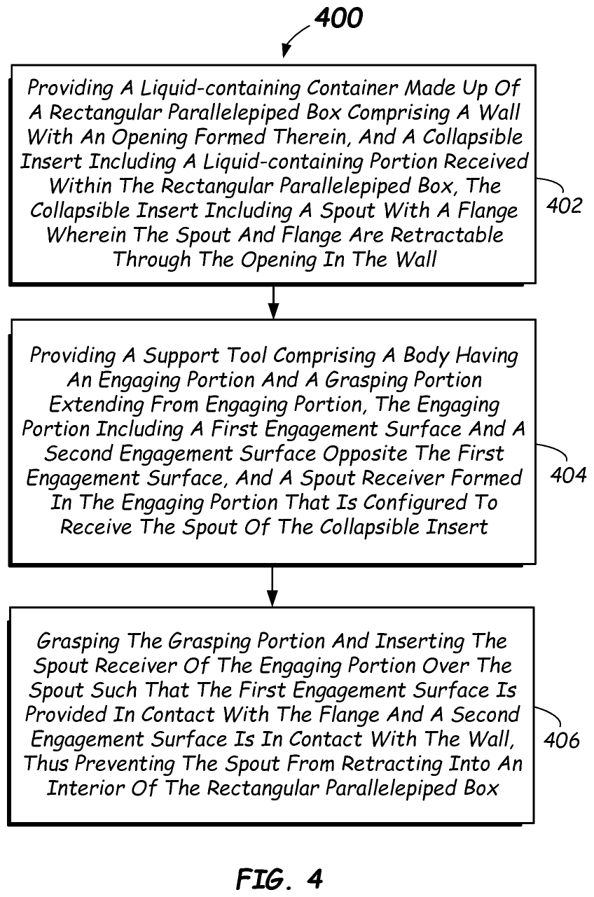

Referring now to FIG. 4, a broad retaining method 400 of a liquid supply system 300 is provided. The retaining method 400 using the spout support tool 100 is provided according to one or more embodiments of the disclosure. The retaining method 400 includes, in block 402, providing a liquid-containing container (e.g., liquid-containing container 200) made up of a rectangular parallelepiped box (e.g., rectangular parallelepiped box 220) comprising a wall (e.g., top wall 222) with an opening 224 (e.g., circular opening 224) formed therein, and a collapsible insert (e.g., collapsible insert 226) including a liquid-containing portion (e.g., liquid-containing portion 228) received within the rectangular parallelepiped box, the collapsible insert including a spout (e.g., spout 230) with a flange (e.g., flange 232) wherein the spout and flange are retractable through the opening in the wall.

The method 400 further includes, in block 404, providing a support tool (e.g., support tool 100) comprising a body (e.g., body 102) having an engaging portion (e.g., engaging portion 104) and a grasping portion (e.g., grasping portion 106) extending from the engaging portion, the engaging portion further including a first engagement surface (e.g., first engagement surface 108) and a second engagement surface (e.g., second engagement surface 110) located opposite from the first engagement surface, and a spout receiver (e.g., spout receiver 112) formed in the engaging portion that is configured to receive the spout of the collapsible insert.

The method 400 further includes, in block 406, grasping the grasping portion and inserting the spout receiver of the engaging portion over the spout such that the first engagement surface is provided in contact with the flange and a second engagement surface is in contact with the wall, thus preventing the spout from retracting into an interior of the rectangular parallelepiped box.

While the disclosure is susceptible to various modifications and alternative forms, specific spout support tools, liquid delivery systems, and method embodiments have been shown by way of example in the drawings and are described in detail herein. It should be understood, however, that it is not intended to limit the invention to the particular spout support tools, liquid delivery systems, and methods disclosed but, to the contrary, the intention is to cover all modifications, equivalents, and alternatives falling within the scope of the claims.

What is claimed is:

1. A liquid supply system, comprising:
a liquid-containing container made up of a rectangular parallelepiped box comprising a wall with an opening formed therein, and a collapsible insert including a liquid-containing portion received inside of the rectangular parallelepiped box, the collapsible insert further including a spout with a flange wherein the spout and flange are retractable through the opening in the wall; and
a support tool comprising a body having an engaging portion and a grasping portion extending from engaging portion, the engaging portion including a first engagement surface engaged with a surface of the wall and a second engagement surface opposite the first engagement surface, and a spout receiver formed in the engaging portion that is configured to be received under the flange of the spout of the liquid-containing container to support the spout.

2. The liquid supply system of claim 1 wherein the support tool prevents the spout from retracting into the rectangular parallelepiped box upon removal of liquid from the liquid-containing portion.

3. The liquid supply system of claim 1 wherein the grasping portion further comprises an aperture.

4. The liquid supply system of claim 3 wherein the aperture has at least one liquid supply tube received there through.

5. The liquid supply system of claim 4 wherein the least one liquid supply tube is also received into the spout.

6. The liquid supply system of claim 5 wherein the at least one liquid supply tube is coupled to an analyzer.

7. The liquid supply system of claim 1 wherein the wall with the opening formed therein is a top wall of the rectangular parallelepiped box.

8. The liquid supply system of claim 1 wherein the grasping portion extends approximately perpendicularly from engaging portion and further extends away from the wall.

9. The liquid supply system of claim 1 wherein the spout receiver is received underneath and in contact with the flange of the spout.

10. A support tool, comprising:
a body having an engaging portion and a grasping portion extending from engaging portion, the engaging portion including a first engagement surface and a second engagement surface opposite the first engagement surface, and a spout receiver formed in the engaging portion that is configured to receive and support a spout of a liquid-containing container.

11. The support tool of claim 10, wherein the first engagement surface comprises a planar surface.

12. The support tool of claim 10, wherein the grasping portion comprises an aperture.

13. The support tool of claim 12, wherein the aperture comprises a circular hole configured to receive a liquid supply tube.

14. The support tool of claim 12, wherein the aperture is positioned in line with a center of a width W1 of the spout receiver.

15. The support tool of claim 10, wherein the spout receiver comprises an open end, two parallel sides, and an arcuate portion extending between the two parallel sides.

16. The support tool of claim 10, wherein the grasping portion extends approximately perpendicularly from the engaging portion.

17. The support tool of claim 10, wherein the grasping portion is thicker than the engaging portion.

18. The support tool of claim 10, wherein the spout receiver includes a radius along an upper edge thereof.

19. The support tool of claim 10, wherein the grasping portion extends laterally to a full width of the engaging portion.

20. A retaining method of a liquid supply system, comprising:
providing a liquid-containing container made up of a rectangular parallelepiped box comprising a wall with an opening formed therein, and a collapsible insert including a liquid-containing portion received within the rectangular parallelepiped box, the collapsible insert including a spout with a flange wherein the spout and flange are retractable through the opening in the wall;
providing a support tool comprising a body having an engaging portion and a grasping portion extending from engaging portion, the engaging portion including a first engagement surface and a second engagement surface opposite the first engagement surface, and a spout receiver formed in the engaging portion that is configured to receive the spout of the collapsible insert; and
grasping the grasping portion and inserting the spout receiver of the engaging portion over the spout such that the first engagement surface is provided in contact with the flange and the second engagement surface is in contact with the wall, thus preventing the spout from retracting into an interior of the rectangular parallelepiped box.
